(19) United States
(12) Patent Application Publication
(10) Pub. No.: US 2021/0293344 A1
(43) Pub. Date: Sep. 23, 2021

(54) ELECTROMAGNETIC ACTUATING DEVICE PARTICULARLY FOR OPENING AND CLOSING A VALVE DEVICE, VALVE DEVICE HAVING AN ACTUATING DEVICE OF THIS KIND, CONTROLLABLE VIBRATION DAMPER COMPRISING AN ACTUATING DEVICE OF THIS KIND AND MOTOR VEHICLE HAVING A VIBRATION DAMPER OF THIS KIND

(71) Applicant: Kendrion (Villingen) GmbH, Villingen-Schwenningen (DE)

(72) Inventor: Björn BERGFELD, Balingen-Endingen (DE)

(21) Appl. No.: 17/257,761

(22) PCT Filed: May 28, 2019
(86) PCT No.: PCT/EP2019/063841

§ 371 Date: Jan. 4, 2021

(30) Foreign Application Priority Data
Jul. 6, 2018 (DE) 10 2018 116 487.4

(51) Int. Cl. F16K 31/06; H01F 7/08; F16F 9/46

(52) U.S. Cl. CPC F16K 31/0675; F16F 9/464; H01F 7/081

(57) ABSTRACT

A gear ring carrier part for a two- or multi-component gear is provided, the gear ring carrier part having a circular ring section rotating in the circumferential direction about an axis of rotation, a gear ring arranged radially on the outside of the circular ring section, and an extension extending radially inward from the circular ring section. The extension having a first extension face and a second extension face, a number of first ribs and an equal number of first pockets being arranged on the first extension face, and/or a number of second ribs and an equal number of second pockets being arranged on the second extension face, the first ribs and the first pockets and/or the second ribs and the second pockets each extending radially and being arranged adjacent to one another in the circumferential direction.

The present invention relates to an electromagnetic actuating device, in particular for opening and closing a valve device, and to a valve device with such an actuating device. The invention also relates to a controllable vibration damper comprising such an actuating device and a motor vehicle with such a vibration damper.

Electromagnetic actuating devices are used, among other things, to open and close all types of valves. According to a typical structure, the electromagnetic actuating devices comprise a coil unit that can be supplied with a current, with which, when current is supplied, an armature mounted movably along a longitudinal axis of the actuating device can be moved relative to a pole core between a retracted position and an extended position. Furthermore, the electromechanical actuating devices have a ram which interacts with the armature and is movably mounted along the longitudinal axis and has a first end, where the ram interacts with a closure element for opening and closing the valve device. While the first end of the ram usually projects from the electromechanical actuating device, a second end is located in the interior of the electromechanical actuating device and is often surrounded by the armature and/or the coil unit that can be supplied with a current. A valve device with such an electromechanical actuating device is for example known from DE . . . .

As already mentioned, the armature and the ram are displaced along the longitudinal axis as a result of the energization of the energizable coil. The valve device is operated in many cases in the following way: If the ram is moved toward the valve seat, the closure element is pressed into the valve seat and the valve device is therefore closed. If the ram is moved away from the valve seat, the valve device opens. Depending on the state, the flow of a pressure medium is blocked or enabled. Compressed air or a hydraulic fluid can for example be used as the pressure medium.

A spring is often used as a return element, which moves the ram into an end position when the coil is not supplied with a current. Depending on whether the valve device is open or closed in this end position, it is a “normally open” or “normally closed” valve device. For the sake of completeness it should be mentioned that the end position can also be determined by means of a permanent magnet that acts on the armature.

When the electromechanical actuating device is in operation, at least the magnetic forces transmitted to it by the armature and generated by the energizable coil unit and the restoring forces generated by the spring act on the ram. In particular when a hydraulic fluid such as oil is used as the pressure medium, a force originating from the pressure of the hydraulic fluid also acts on the ram and the closure element. This force will be referred to below as fluid force.

While the restoring forces of the spring can be easily determined in advance using the spring characteristic and the magnetic forces using the current strength of the current supply, the fluid force acts not only on the ram but also on the closure element, wherein the fluid force also depends on whether the closure element is in contact with the valve seat or is arranged away from the valve seat. In addition, the fluid force is in many cases dependent on the volume flow of the pressure medium through the valve device. Even a small increase in the volume flow can therefore lead to a sudden increase in the fluid force acting on the ram and on the closure element, which cannot easily be compensated for by the magnetic force and the restoring force. This results in an uncontrollable opening and closing behavior of the closure element. It requires a great deal of control effort to adapt the magnetic forces to the opening and closing behavior, and large currents must be used, which on the one hand causes the electromechanical actuating device to be operated in an uneconomic way, and on the other hand generates a relatively large amount of heat in the electromechanical actuating device, which heat is poorly dissipated and consequently can lead to increased wear resulting from thermal loads. In addition, there can be operating states in which the fluid forces acting on the closure element suddenly increase so much that the closure element can no longer open at all. Depending on the design of the valve device, no countermeasures can be taken, and therefore such operating states have to be avoided, which limits the application range of the electromechanical actuating device and the valve device.

The object of an embodiment of the present invention is to create an electromechanical actuating device and a valve device, with which a controlled opening and closing behavior can be provided for a large range of volume flows through the valve device. Furthermore, one embodiment of the present invention is based on the object of creating a vibration damper with such a valve device for a motor vehicle, which can be operated in a controlled manner over a large range of volume flows through the valve device. In addition, a motor vehicle is to be proposed, which has a vibration damper that can be operated in a controlled manner within a large range of volume flows.

This object is achieved with the features specified in claims 1, 6, 7, and 8. Advantageous embodiments are the subject of the dependent claims.

One embodiment of the invention relates to an electromagnetic actuating device, in particular for opening and closing a valve device, comprising a coil unit which can be supplied with a current, with which, when current is supplied, an armature mounted movably along a longitudinal axis of the actuating device can be moved be tween a retracted position and an extended position, a ram which interacts with the armature and is movably mounted along the longitudinal axis and has a first end, where the ram interacts with a closure element for opening and closing the valve device, and a second end, wherein the ram is arranged so that it projects with the first end into a first chamber, in which a pressure medium is under a first pressure, and projects with the second end into a second chamber, in which the pressure medium is under a second pressure.

The first chamber and the second chamber can be designed such that the pressures p1 and p2 differ from one another. They can be fluidically connected in such a way that the pressures p1 and p2 change in a selectable relationship to one another, in particular when the volume flow changes, in particular through the first chamber. If, for example, the first pressure p1 rises sharply as a result of an increasing volume flow through the first chamber, this can result in the second pressure p2 also rising. Since the first end of the ram projects into the first chamber and the second end into the second chamber, the fluid force acting on the first end of the ram in the first chamber is at least partially balanced or negated by the fluid force acting on the second end of the ram in the second chamber. The ram is stabilized or braced fluidically, and in particular hydraulically as a result. The opening and closing behavior of the ram and the closure element interacting with the ram can consequently be controlled over a wide range of the volume flow flowing through the first chamber without a correspondingly large magnetic force having to be provided for this purpose. The magnetic force can therefore only be selected so large that the closure element can be opened or closed in a controlled manner The magnetic force therefore does not have to be used to compensate for the fluid forces acting on the ram. According to the proposal, a comparatively small magnetic force is sufficient to move the ram along the longitudinal axis and consequently to open and close the valve device. The electromagnetic actuating device can be operated with comparatively low currents and thus more economically.

According to a further embodiment, the ram has a channel with a first opening and a second opening, wherein the pressure medium can flow through the channel In this case, the pressure medium serves as a heat transfer medium, particularly when a hydraulic fluid is used as the pressure medium, so that the heat generated in the electromagnetic actuating device during operation of the electromechanical actuating device can be dissipated from the ram. Wear due to thermal loads is reduced.

In a further developed embodiment, the first opening can be arranged in the first chamber and the second opening in the second chamber, so that fluid communication is provided between the first chamber and the second chamber. The above-described heat dissipation is still guaranteed, and no further pressure medium line has to be provided between the first and the second chamber in order to establish the fluid communication. Due to the design of the channel, for example the diameter or changes in diameter and the size and orientation of the first and the second opening, the fluid forces acting on the first end and the second end of the ram can be influenced in a targeted manner For example, a certain pressure loss can be brought about in a targeted manner when flowing through the channel. As already mentioned, the ram can be moved back and forth along the longitudinal axis. The openings can be arranged and dimensioned in such a way that the surfaces effective for the fluid forces are specifically changed. The fluid forces acting on the ram can therefore be adjusted and a controlled opening and closing behavior of the ram, and consequently of the closure element interacting with it, can be provided.

In a further developed embodiment, the first opening can interact fluidically with a first diaphragm and/or the second opening can interact fluidically with a second diaphragm. The fluidic interaction of the first and/or the second opening can be made possible, for example, by the pressure medium having to flow through the first or second diaphragm when it enters the first and/or second chamber. The same can be provided when leaving the first or the second diaphragm. In this way, certain pressure ratios can be set between the first pressure and the second pressure, which contribute to a controlled opening and closing behavior of the ram and consequently of the closure element interacting with it.

In a further embodiment, the ram can be cylindrical and have a first diameter, the closure element can have a second diameter that differs from the first diameter, and the size of the first diaphragm and/or the second diaphragm can be adapted to the first diameter and the second diameter. In some cases it may be structurally unavoidable to have to provide different diameters for the closure element and for the ram. For example, the bearings, in particular sliding bearings, which are used for mounting the ram, may be available in specific diameters that do not correspond to the diameter of the closure element. Custom-made closure elements or bearings may not be economically acceptable. For example, when the first diameter is larger than the second diameter, annular surfaces can arise at the first end of the ram, which lead to an opening force which is not compensated for by the closure element. As mentioned at the beginning, comparatively small increases in the volume flow can lead to suddenly increasing fluid forces acting on the ram. This effect is particularly pronounced when the first diameter and the second diameter are different. This effect can be counteracted by using the first and/or the second diaphragm. The adaptation of the diaphragms to the particular diameter of the closure element and the ram is a technical measure that is comparatively easy to implement.

One embodiment of the invention relates to a valve device comprising a first chamber, in which a valve seat and a closure element are arranged, wherein the valve seat can be closed with the closure element, a second chamber and an electromagnetic actuating device according to one of the previous embodiments, with a ram mounted movably along the longitudinal axis, with a first end, with which the ram interacts with the closure element to open and close the valve seat, and a second end, wherein the ram is arranged so that it projects with the first end into the first chamber, in which a pressure medium is under a first pressure, and projects with the second end into a second chamber, in which the pressure medium is under a second pressure.

The technical effects and advantages that can be achieved with the proposed valve device correspond to those that have been discussed for the present electromagnetic actuating device. In summary, the following should be noted: Because the ram projects into both the first chamber and the second chamber, fluid forces that at least partially cancel one another out act on the ram. As mentioned, the fluid forces can increase significantly even with smaller volume flows through the valve device, which leads to an uncontrolled opening and closing behavior of the ram and the closure element that interacts with it. With the proposed option of allowing these fluid forces to act at both ends of the ram and at least partially canceling each other out, this leads to hydraulic tensioning of the ram and to a controlled opening and closing behavior of the ram and the closing element that interacts with it, without large magnetic forces needing to be provided.

One design of the invention relates to a controllable vibration damper, in particular for motor vehicles, with a working cylinder, a piston which can be moved back and forth in the working cylinder and divides the working cylinder into a first work space and a second work space, wherein the first work space and the second work space are each connected via a pressure medium line to a valve device according to the design described above, for controlling the vibration damper.

One embodiment of the invention relates to a motor vehicle with a vibration damper according to the embodiment described above.

The technical effects and advantages that can be achieved with the proposed vibration damper and the proposed motor vehicle correspond to those that have been discussed for the present electromagnetic actuating device and the present valve device. In summary, the following should be noted: Because the ram projects into both the first chamber and the second chamber, fluid forces that at least partially cancel one another out act on the ram. As mentioned, the fluid forces can increase significantly even with smaller volume flows through the valve device, which leads to an uncontrolled opening and closing behavior of the ram and the closure element that interacts with it. With the proposed option of allowing these fluid forces to act at both ends of the ram and at least partially canceling each other out, this leads to hydraulic tensioning of the ram and to a controlled opening and closing behavior of the ram and the closing element that interacts with it, without large magnetic forces needing to be provided.

Exemplary embodiments of the invention are explained in more detail below with reference to the accompanying drawings. In the drawings:

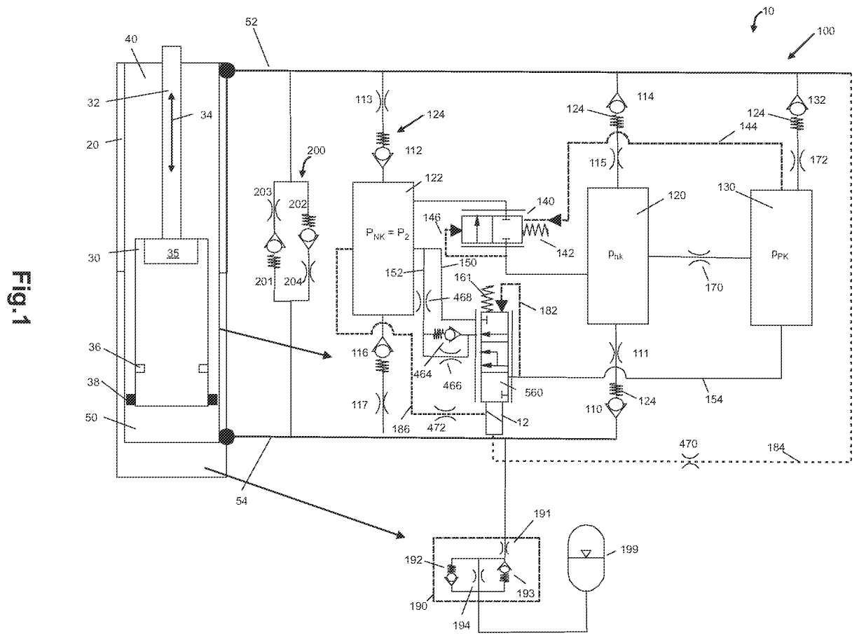

FIG. 1 shows a circuit diagram of a hydraulic system of a first exemplary embodiment of a vibration damper;

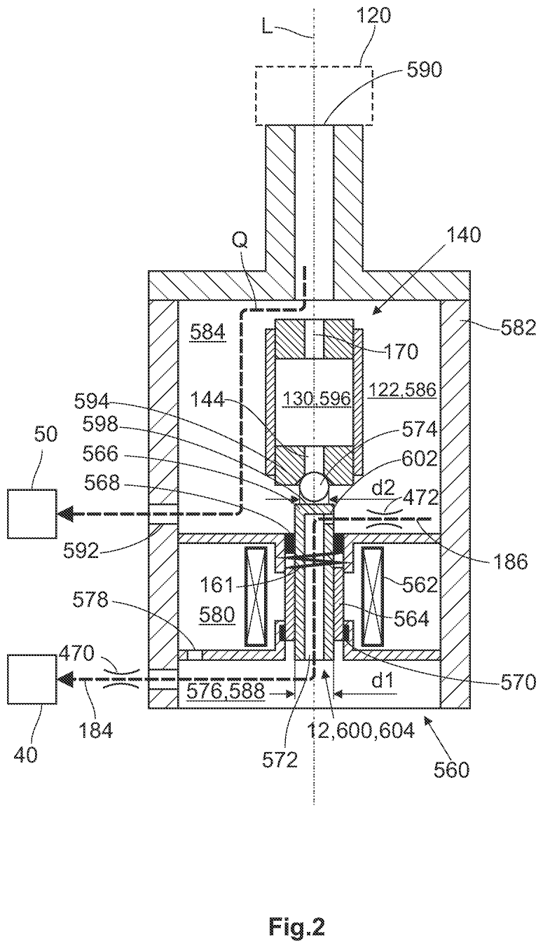

FIG. 2 shows a basic illustration of a valve of the first exemplary embodiment of an electromagnetic actuating device according to the invention in a first operating state, which is integrated in the hydraulic system shown in FIG. 1;

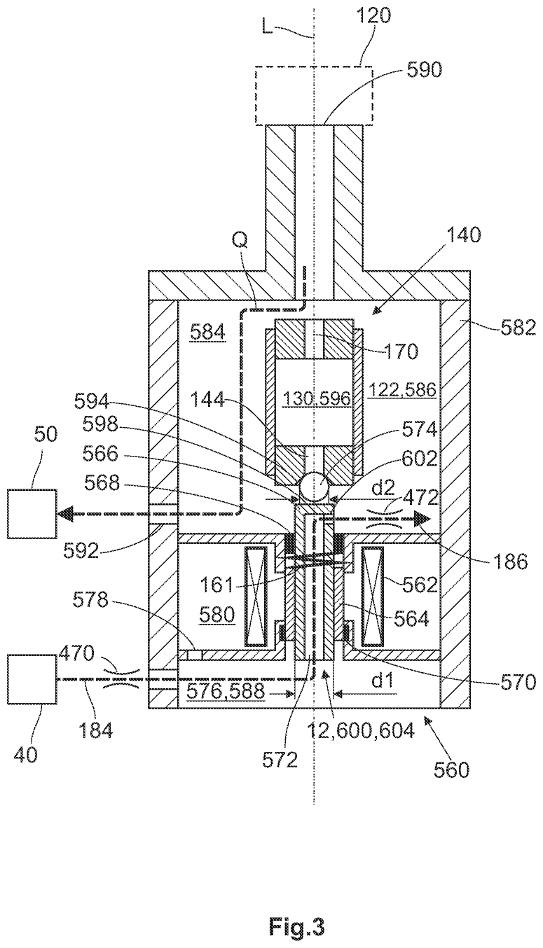

FIG. 3 shows the actuating device shown in FIG. 2 in a second operating state; and

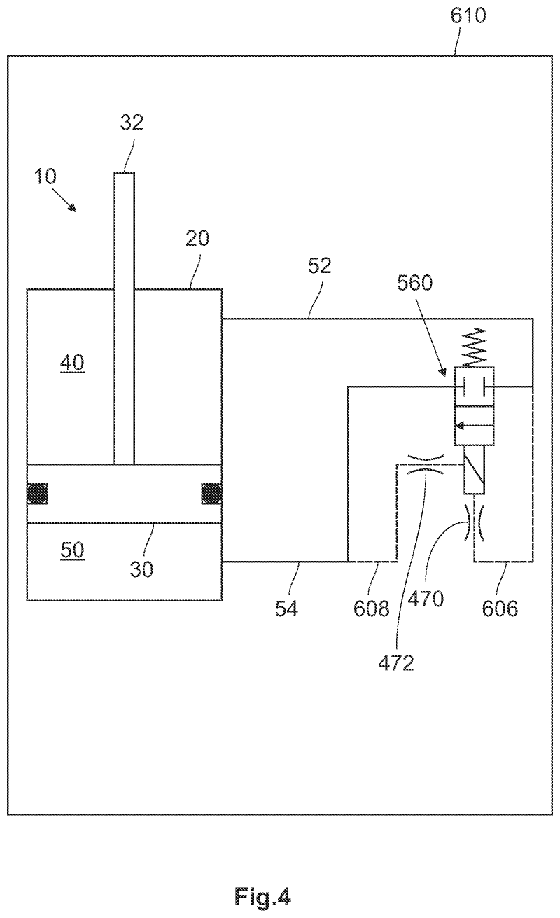

FIG. 4 shows a basic illustration of a motor vehicle with a hydraulic system of a second exemplary embodiment of a vibration damper.

FIG. 1 shows a first exemplary embodiment of a controllable vibration damper 10 based on a circuit diagram of a hydraulic system. The vibration damper 10, which is for example mounted on the wheel suspension of a wheel of a motor vehicle in order to adjust the damping of the wheel suspension and thus the damping of the vehicle when driving, has a damper tube, which is referred to below as the working cylinder 20. In this working cylinder 20 a piston 30, which is attached to a piston rod 32, can be moved back and forth. The piston 30 is coupled to the wheel suspension of the motor vehicle. The reciprocating movement of the piston 30 is marked by a movement arrow 34 in FIG. 1. As can be seen, the piston 30 can move back and forth in the working cylinder 20, namely firstly upwards and another time downwards. In the following, an upwardly moving piston 30 is referred to as pulling, whilst a downwardly moving piston 30 is referred to as pushing. Accordingly, above the piston 30 there is a first work space 40, which is referred to as the “pulling chamber”, and below the piston 30 a second work space 50, which is referred to as the “pressure chamber”.

The first work space 40 (pulling chamber) and the second work space 50 (pressure chamber) are connected to a hydraulic system 100, in which a pressure medium is conducted, which should be a hydraulic fluid such as oil. In principle, however, the hydraulic system can also be designed as a pneumatic system and compressed air can be used as the pressure medium. For reasons of simpler representation, the hydraulic system 100 is shown in as being arranged outside the working cylinder 20 in FIG. 1. However, this is only chosen for reasons of presentation. In fact, the entire hydraulic system 100 sits inside the cup-shaped piston 30 of the vibration damper.

The hydraulic system comprises a first pressure medium line 52, which is connected to the first work space 40, and a second pressure medium line 54, which is connected to the second work space 50. For this purpose, the piston 30 has bores 36, shown only schematically in FIG. 1, via which the installation space 35 within the piston 30 is hydraulically connected to the first work space 40 (pulling chamber). In addition, the first work space 40 (pulling chamber) and the second work space 50 (pressure chamber) are sealed by a radial seal 38 running around the outer circumference of the piston 30. The front end of the piston 30 is therefore hydraulically connected to the second work space 50 (pressure chamber) via a suitable opening.

The hydraulic system 100 connected to the two pressure medium lines 52, 54 has a bridge circuit with four non-return valves 110, 112, 114, 116. These non-return valves 110, 112, 114, 116 are connected crosswise in the forward direction, wherein the connection of a first bridge branch to the two oppositely connected non-return valves 110, 114 forms a high-pressure chamber 120 and the connection of the second bridge branch to the two further opposing non-return valves 112, 116 leads to a low-pressure chamber 122. As FIG. 1 clearly shows, the first non-return valve 110 and the fourth non-return valve 116 are connected to the lower pressure medium line 54 and are therefore connected to the second work space 50 (pressure chamber). The first non-return valve 110 is connected in the forward direction to the second work space 50 (pressure chamber). The fourth non-return valve 116, on the other hand, is connected in the reverse direction to the second work space 50. The second non-return valve 112 and the third non-return valve 114, however, are connected to the upper pressure medium line 52. The second non-return valve 112 is connected in the reverse direction to the first work space 40 (pulling chamber) here, and the third non-return valve 114 is connected in the forward direction.

As the illustration in FIG. 1 further shows, the main diaphragms 111, 113, 115, and 117 are in series with the four non-return valves 110, 112, 114, and 116 respectively. The first main diaphragm 111 is located between the first non-return valve 110 and the high-pressure chamber 120. The second main diaphragm 113 is located between the first pressure medium line 52 and the second non-return valve 112. The third main diaphragm 115 is located between the high-pressure chamber 120 and the third non-return valve 114. Finally, the fourth main diaphragm 117 is located between the second pressure medium line 54 and the fourth non-return valve 116. The four non-return valves 110, 112, 114, and 116 of the bridge circuit are preferably provided with adjustable spring elements 124. In this way, the opening behavior of the in dividual non-return valves 110, 112, 114, and 116 can be selected to be preset, depending on how the spring force of the adjustable spring elements 124 is designed.

The hydraulic system 100 also has a main slide 140, an electromagnetic valve device 560 according to the invention and a pilot chamber 130, also referred to as a pilot pressure chamber. The valve device 560 is shown in more detail in FIGS. 2 and 3 and comprises an electromagnetic actuating device 12 with an electromagnet.

The pilot chamber 130 is connected to the first pressure medium line 52 via a fifth non-return valve 132. This fifth non-return valve 132 is, like the third non-return valve 114, located in the forward direction to the first work space 40 (pulling chamber). The pilot chamber 130 is hydraulically connected to the high-pressure chamber 120 via a fifth main diaphragm 170. A sixth main diaphragm 172 is connected between the fifth non-return valve 132 and the pilot chamber 130.

The valve device 560 is connected between the low-pressure chamber 122 and the pilot chamber 130 and is designed as a 3/3 valve, which works proportionally. The low-pressure chamber 122 is connected to the valve device 560 via two connecting lines 150, 152. While the first connecting line 150 has no further hydraulic elements, a non-return valve 464 and a sixth main diaphragm 466 are connected in parallel in the second connecting line 152, starting from the valve device 560. A seventh main diaphragm 468 is connected in series with the non-return valve 464 and the sixth main diaphragm 466.

Another supply line 154 is located between the valve device 560 and the pilot chamber 130. As in the exemplary embodiment of FIG. 1, the valve device 560 works against a spring device 161 and against a pressure coming from the pilot chamber 130, which pressure is directed, via a control line 182 branching off from the supply line 154 and working parallel to the spring force of the spring device 161, against the actuating device 12. The main diaphragms 466, 468 and the non-return valve 464 have the purpose of setting a medium damper characteristic on the vibration damper 10 in the event of a power failure (failsafe).

The main slide 140 is designed as a 2/2 valve, but is an exclusively hydraulic valve. The main slide 140 connects the low-pressure chamber 122 to the high-pressure chamber 120. The main slide 140 works first against a spring device 142 and secondly against a pressure of the pilot chamber 130 arriving via the control line 144. On the other hand, the main slide 140 is influenced on its opposite side by a control line 146 coming from the high-pressure chamber 120.

For the sake of completeness, it should also be mentioned that the controllable vibration damper 10 shown in FIG. 1 additionally has a bottom valve 190 in the base of the working cylinder 20. This bottom valve 190 is known in itself in vibration dampers and is connected between the lower pressure medium line 54 and a tank 199. For this purpose, the bottom valve 190 for example has a first tank diaphragm 191 between the lower pressure medium line 54 and the tank 199, which diaphragm is connected to the lower pressure medium line 54. On the side facing away from the pressure medium line 54, two anti-parallel connected non-return valves 192, 193 are placed on the first tank diaphragm 191, with a second tank diaphragm 194 additionally being connected in parallel.

Finally, a so-called blow-off valve 200, which is also known in itself, is connected between the two pressure medium lines 52, 54. This blow-off valve 200 is used to set a maximum achievable damping force on the vibration damper 10. For this purpose the blow-off valve 200 for example consists of two anti-parallel connected non-return valves 201, 202, as shown, each of which is preceded by a blow-off diaphragm 203, 204.

The operation of the controllable vibration damper of FIG. 1 is as follows.

It is initially assumed that the piston 30 moves upwards and thus the first work space 40 (pulling chamber) is reduced. This mode of operation is referred to below as pulling operation. As a result, the pressure in the first work space 40 (pulling chamber) increases as the piston 30 continues to move. The pressure in the pressure medium line 52 increases. The second non-return valve 112 is in the reverse direction, so that this pressure cannot reach the low-pressure chamber 122. However, the third non-return valve 114 is connected in the forward direction, so that, when the spring force of the adjustable spring element 124 of the non-return valve 114 is overcome, the non-return valve 114 opens and the pressure of the pressure medium line 52 is present in the high-pressure chamber 120. In addition, the fifth non-return valve 132 is located in the forward direction with respect to the pilot chamber 130. Due to the connection between the high-pressure chamber 120 and the pilot chamber 130, a pressure determined via the main diaphragms 170, 172 is established in the pilot chamber 130, wherein the pressure coming from the low-pressure chamber 122 via the valve device 560 is present in the pilot chamber 130 as counter pressure. The valve device 560 can be controlled with suitable energization, so that the pressure ultimately established in the pilot chamber 130 is set on the basis of the energization of the valve device 560. This pressure acting in the pilot chamber 130 is fed to the main slide 140 via the control line 144, so that the pressure in the pilot chamber 130 also influences the position of the main slide 140. In this way, the damper characteristics of the vibration damper can be adjusted when the piston 30 is subjected to tensile load by correspondingly energizing the valve device 560.

If the opposite movement of the piston 30 is now considered, that is to say in the downward direction (pushing operation), the pressure in the second pressure medium line 54 increases. In this case, the fourth non-return valve 116 is in its reverse position and the first non-return valve 110 is in the forward direction with respect to the high-pressure chamber 120. In this case, the high-pressure chamber 120 is in communication with the pilot chamber 130 via the fifth main diaphragm 170, and a similar mechanism of action is established as above for the pressure load.

In FIG. 2, a first exemplary embodiment of the valve device 560 according to the invention is shown in greater detail on the basis of a basic and partial illustration.

The valve device 560 comprises a housing 582, which encloses a cavity 584. This cavity 584 is divided into a first chamber 586 and a second chamber 588. The first chamber 586 has an inlet 590 and an outlet 592, so that a pressure medium, not shown, such as air or a hydraulic fluid can flow through the first chamber 586. In the example shown, the inlet 590 is connected to the high-pressure chamber 120 (cf. FIG. 1). The first chamber 586 is formed by the already mentioned low-pressure chamber 122.

The flow of the pressure medium between the inlet 590 and the outlet 592 represents a main volume flow Q through the valve device 560. In the first chamber 586 there is a valve seat 594, which can be closed and opened with a closure element 574. In the open state, the pressure medium can flow into a third chamber 596, which is arranged in the already mentioned main slide 140, with which the inlet 590 can be opened and closed. The third chamber 596 is formed by the pilot chamber 130 also already mentioned.

The control line 144 is formed between the valve seat 594 and the third chamber 596, and the fifth main diaphragm 170 is arranged between the third chamber 596 and the inlet 590 and has a throttling effect on the pressure medium flowing through it.

The actuating device 12 comprises a coil unit 562 that can be supplied with a current, with which an armature 564 can be moved along a longitudinal axis L of the actuating device 12. A ram 566, sometimes also referred to as a shaft, is firmly con nected to the armature 564, so that the ram 566 executes the same movements as the armature 564. So that the armature 564 and the ram 566 can move along the longitudinal axis L, a first bearing 568 and a second bearing 570 are provided, which can for example be designed as sliding bearings.

The ram 566 has a first end 598 and a second end 600. The ram 566 is arranged such that its first end 598 facing the closure element 574 is located in the first chamber 586 or in the low-pressure chamber 122, while its second end 600 facing away from the closure element 574 is arranged in the second chamber 588, which is formed by a magnet chamber 576 in the example shown. The magnet chamber 576 is connected via a passage opening 578 to a coil space 580 surrounding the coil unit 562, so that the same pressure prevails in the coil space 580 and in the magnet chamber 576.

In order to be able to establish a fluid connection between the first chamber 586 and the second chamber 588, the ram 566 has a channel 572 with a first opening 602 and a second opening 604. The first opening 602 is arranged in the first chamber 586 and the second opening 604 is arranged in the second chamber 588. The plane defined by the first opening 602 runs parallel to the longitudinal axis L, while the plane defined by the second opening 604 runs perpendicular to the longitudinal axis L.

The channel 572 interacts fluidically with a first diaphragm 472 via the first opening 602, and fluidically interacts with a second diaphragm 470 via the second opening 604. As can be seen from FIG. 1, the first diaphragm 472 is arranged in a first control line 184 and the second diaphragm 470 is arranged in a second control line 186.

The ram 566 interacts with the closure element 574, which is part of the main slide 140. The connection between the pilot chamber 130 and the low-pressure chamber 122 can be opened and closed with the closure element 574. In the example shown the closure element 574 is of a spherical design.

The ram 566 has a diameter dl and the spherical closure element 574 has a diameter d2. The diameter dl can for example be 3 or 4 mm and the diameter d2 2.3 mm In any case, the diameter d1 is larger than the diameter d2. In addition, the diameter of the first diaphragm 472 is greater than the diameter of the second diaphragm 470.

Regardless of whether the vibration damper 10 is in pushing or pulling operation, a main volume flow Q from the pressure chamber 120 through the low-pressure chamber 122 is established if the main slide 140 is open. From the low-pressure chamber 122, the pressure medium flows on to the first work space 40 in pushing operation and to the second work space 50 in pulling operation (cf. FIGS. 2 and 3).

As a result, different pressures act on the ram 566, namely pressure pNK of the low-pressure chamber 122, which corresponds to a first pressure p1, and a second pressure p2 of the magnet chamber 576.

As already explained, the diameter of the first diaphragm 472 is greater than the diameter of the second diaphragm 470. In the pushing operation shown in FIG. 2, the pressure medium also flows from the low-pressure chamber 122 through the con trol line 186 and the first diaphragm 472 into the channel 572, and then into the magnet chamber 576 and from there through the control line 184 and the second diaphragm 470 into the first work space 40.

In the pulling operation shown in FIG. 3, the pressure medium flows from the first work space 40 through the control line 184 and the second diaphragm 470 into the magnet chamber 576, and from there through the channel 572 and through the control line 186 and the first diaphragm 472 into the low-pressure chamber 122. From there, the pressure medium flows into the second work space 50 as described for the main volume flow Q.

During pushing operation, closing forces acting on the ram 560 result, since the dynamic pressure in the magnet chamber 576 increases due to the fact that the diaphragm 472 has a larger diameter than the diaphragm 470. As a result, the opening force acting on the annular surface of the ram 566 facing the closing element 574 is more than compensated, and the ram 566 opens in a more controlled manner over the main volume flow Q due to the slight hydraulic tensioning. The magnetic force to be applied by the coil unit 562 can therefore be smaller, which improves the energy efficiency of the controlled vibration damper 10.

During pulling operation, the flow through channel 572 is in the opposite direction. Here, too, closing forces acting on the ram 566 result, since the pressure pHK of the high-pressure chamber 120 would also be present in the magnet chamber 576 and would therefore be equal to the second pressure p2 if the pressure medium did not have to flow through the first diaphragm 472. Without the first diaphragm 472, the closing force would be very great and there would be the risk that the actuating device 12 would not open at all. By suitably selecting the size of the first diaphragm 472, the second pressure p2 can be set such that the closing force has the desired value.

As the main volume flow Q increases, both the first pressure p1 in the first chamber 586 and the low-pressure chamber 122 and the second pressure p2 in the magnet chamber 576 increase, as a result of which the actuating device 12 automatically stabilizes.

FIG. 4 shows a basic illustration of a motor vehicle 610 with a hydraulic system of a second exemplary embodiment of a vibration damper 10. The valve device 560 is designed as a 2/2 valve. Otherwise, the valve device 560 is constructed exactly as shown in FIGS. 2 and 3.

A control line 606, in which the second diaphragm 470 is arranged, branches off from the first pressure medium line 52 connected to the first work space 40. The control line 606 opens into the second chamber 588, which is not explicitly shown in FIG. 4 (see FIGS. 2 and 3). Furthermore, a further control line 608 is provided, which starts from the second pressure medium line 54 and opens into the first chamber 586 (see FIGS. 2 and 3). The first diaphragm 472 is arranged in the control line 608.

### LIST OF REFERENCE NUMBERS

10 Adjustable vibration damper
12 Electromagnetic actuating device
20 Working cylinder
30 Piston
32 Piston rod
34 Movement arrow
35 Installation space
36 Bores
38 Seal
40 First work space (pulling chamber)
50 Second work space (pressure chamber)
52 Pressure medium line
54 Pressure medium line
100 Hydraulic system
110 First non-return valve
111 First main diaphragm
112 Second non-return valve
113 Second main diaphragm
114 Third non-return valve
115 Third main diaphragm
116 Fourth non-return valve
117 Fourth main diaphragm
120 High-pressure chamber
122 Low-pressure chamber
124 Adjustable spring element
130 Pilot chamber
132 Fifth non-return valve
140 Main slide
142 Spring device
144 Control line
146 Control line
150 First connecting line
152 Second connecting line
154 Supply line
161 Spring device
170 Fifth main diaphragm
172 Sixth main diaphragm
182 Control line
184 First control line
186 Second control line
190 Bottom valve
191 First tank diaphragm
192 Non-return valve
193 Non-return valve
194 Second tank diaphragm
199 Tank
200 Blow-off valve
201 Non-return valve
202 Non-return valve
203 Blow-off diaphragm
204 Blow-off diaphragm
464 Non-return valve
466 Main diaphragm
468 Main diaphragm
470 Second diaphragm
472 First diaphragm
560 Valve device
562 Coil unit
564 Armature
566 Ram
568 First bearing
570 Second bearing
572 Channel
574 Closure element
576 Magnet chamber
578 Passage opening
580 Coil space
582 Housing
584 Cavity
586 First chamber
588 Second chamber
590 Inlet
592 Outlet
594 Valve seat
596 Third chamber
598 First end
600 Second end
602 First opening
604 Second opening
606 Control line
608 Control line
610 Motor vehicle
L Longitudinal axis

1. An electromagnetic actuating device, in particular for opening and closing a valve device (560), comprising
a coil unit (562) that can be supplied with a current, with which, when current is supplied, an armature (564) mounted movably along a longitudinal axis (L) of the actuating device (12) can be moved between a retracted position and an extended position,
a ram (566), which interacts with the armature (564) and is movably mounted along the longitudinal axis (L) and has a first end (598), where the ram (566) interacts with a closure element (574) for opening and closing the valve device (560), and a second end (600),
wherein the ram (566) is arranged so that it projects with the first end (598) into a first chamber (586), in which a pressure medium is under a first pressure (p1), and projects with the second end (600) into a second chamber (588), in which the pressure medium is under a second pressure (p2).

2. The electromagnetic actuating device according to claim 1, characterized in that the ram (566) has a channel (572) with a first opening (602) and a second opening (604) and the pressure medium can flow through the channel (572).

3. The electromagnetic actuating device according to claim 2, characterized in that the first opening (602) is arranged in the first chamber (586) and the second opening (604) is arranged in the second chamber (588), so that fluid communication between the first chamber (586) and the second chamber (588) is provided.

4. The electromagnetic actuating device according to claim 3, characterized in that the first opening (602) interacts fluidically with a first diaphragm (472) and/or the second opening (604) interacts fluidically with a second diaphragm (470).

5. The electromagnetic actuating device according to claim 4, characterized in that
the ram (566) is cylindrical and has a first diameter (d1),
the closure element (574) has a second diameter (d2), which differs from the first diameter (d1), and
the size of the first diaphragm (472) and/or the second diaphragm (470) are adapted to the first diameter (d1) and to the second diameter (d2).

6. A valve device (560), comprising
a first chamber (586), in which a valve seat (594) and a closure element (574) are arranged, wherein the valve seat (594) can be closed with the closure element (574),
a second chamber (588), and
an electromagnetic actuating device (12) according to claim 1, with a ram (566) mounted movably along the longitudinal axis (L), with a first end (598), with which the ram (566) interacts with the closure element (574) to open and close the valve seat (594), and a second end (600),
wherein the ram (566) is arranged so that it projects with the first end (598) into the first chamber (586), in which a pressure medium is under a first pressure (p1), and projects with the second end (600) into a second chamber (588), in which the pressure medium is under a second pressure (p2).

7. An adjustable vibration damper, especially for motor vehicles, with
a working cylinder (20),
a piston (30), which can be moved back and forth in the working cylinder (20) and divides the working cylinder (20) into a first work space (40) and a second work space (50), wherein
the first work space (40) and the second work space (50) are each connected via a pressure medium line (52, 54) to a valve device (560) according to claim 6, for controlling the vibration damper (10).

8. A motor vehicle (610) with a controllable vibration damper (10) according to claim 7.
